(19) United States
(12) Patent Application Publication
(10) Pub. No.: US 2025/0138481 A1
(43) Pub. Date: May 1, 2025

(54) SPIRAL SPRING WITH IMPROVED STIFFNESS ADJUSTMENT MEANS

(71) Applicant: The Swatch Group Reseach and Development Ltd., Marin (CH)

(72) Inventors: Mohammad Hussein KAHROBAIYAN, Boudevilliers (CH); Romain Le Moal, Villers-le-Lac (FR); Julien Christan, Bienne (CH)

(73) Assignee: The Swatch Group Reseach and Development Ltd., Marin (CH)

(21) Appl. No.: 18/907,687

(22) Filed: Oct. 7, 2024

(30) Foreign Application Priority Data
Oct. 25, 2023 (EP) 23205853.7

(51) Int. Cl. G04B 18/04; G04B 17/06

(52) U.S. Cl. CPC G04B 18/04; G04B 17/06

(57) ABSTRACT

A spiral spring for a watch resonator mechanism, including a flexible strip (2) wound on itself and having a predefined stiffness and including an arrangement for adjusting its stiffness, including a flexible element (5) arranged in series with the strip, the flexible element (5) connecting one end (4) of the strip to a rigid support (11), to add additional stiffness to the strip (2). The flexible element (5) preferably having a stiffness greater than that of the strip (2). A prestressing device (6) applies a variable force or torque to the flexible element to vary its stiffness, and includes a lever (14) connected to the flexible element and actuatable to transmit the force or the torque to the flexible element, the lever (14) having an end (15) movable in a first direction (D1). A retaining device (25) prevents movement of the lever (14) substantially in a second direction (D2).

### CROSS REFERENCE TO RELATED APPLICATION

This application claims priority from European Patent Application No. 23205853.7, filed Oct. 25, 2023, which is hereby incorporated by reference in its entirety into this application.

### TECHNICAL FIELD OF THE INVENTION

The invention relates to a spiral spring for a watch resonator mechanism, the spiral spring being provided with improved means for adjusting the stiffness of said spiral spring.

The invention also relates to a watch resonator mechanism fitted with such a spiral spring.

### TECHNOLOGICAL BACKGROUND

Most mechanical watches today are fitted with a balance spring and a Swiss lever escapement mechanism. The balance-spring is the watch's time base. It is also known as the resonator.

In turn, the escapement has two main functions:
keep the resonator moving back-and-forth;
counting these back-and-forth movements.

A mechanical resonator requires an inertial element, a guide and an elastic return element. Traditionally, a spiral spring acts as an elastic return element for the inertial element formed by a balance. This balance is guided in rotation by pivots that turn in ruby plain bearings.

The spiral spring generally needs to be adjustable to improve the accuracy of a watch. To this end, means are used to adjust the stiffness of the spiral spring, such as an index-assembly to modify the effective length of the spring. In this way, its stiffness is modified to adjust the rate accuracy of the watch. However, the effect of a traditional index-assembly for adjusting the rate remains limited, and it is not always effective in making the setting sufficiently accurate, in the range of a few seconds or a few tens of seconds per day.

Other spiral springs include integrated adjustment means. In these spiral springs, the rate is not adjusted by modifying the effective length of the spiral spring, but by applying a force or a torque to a flexible element arranged in series with the spiral. This makes it possible to modify the stiffness of the flexible element, which partly determines the return force acting on the balance, and consequently the stiffness of the spiral spring as a whole. By adjusting the stiffness of the spiral spring, it is possible to regulate the rate of the regulating member. Such a spiral spring with a flexible element is described, for example, in the patent applications EP4009115 and CH0700385/2021.

In these cases, the usual systems cannot be used, as they are not compatible with the spiral spring adjustment device. In addition, as the rate has to be adjusted very finely, it is essential that there is no play between the spiral and the areas where it interacts with the index-assembly mechanism. Otherwise, there is a risk of altering the rate in the event of an impact, if the spiral does not reposition itself in exactly the same way after the impact.

To use such a spiral spring, an index-assembly system has been described in the patent applications EP22177059.7 and CH000678/2022. The racking system comprises a stud holder in two parts that can be moved relative to each other, each part being equipped with a stud on which the flexible element is mounted on the one hand, and the prestressing means acting on the flexible element on the other. In this way, by moving the two parts relative to each other, the force or the torque applied to the flexible element is modified in order to adjust the stiffness of the spiral spring.

However, in this index-assembly system, the adjustment means are actuated tangentially to the spiral spring, as the moving parts perform a circular movement around the spiral spring. This tangential actuation is produced by an index-assembly system that is complex to implement.

To avoid this problem, it has been devised to actuate the lever of the adjustment device by an actuator which performs a substantially rectilinear movement, for example by pulling or pushing the lever, by means of an actuator, either directly or via an element joining the actuator to the lever. The actuator comprises, for example, a hook engaged with the lever.

However, the area of contact between the actuator and the lever causes friction problems when the lever is moved relative to the actuator, particularly when the reference mark on the regulating member is adjusted. Indeed, if the spiral spring is moved, the lever may be subjected to friction from the actuator and move the hook, so that the rate setting is altered.

### SUMMARY OF THE INVENTION

The aim of the present invention is to alleviate some or all of the aforementioned drawbacks by offering a spiral spring equipped with effective and accurate adjustment means, configured in particular to avoid disturbing the operation of the regulating member.

To this end, the invention relates to a spiral spring, in particular for a watch resonator mechanism, the spiral spring comprising a flexible strip wound on itself in a plurality of turns, the strip having a predefined stiffness, the spiral spring including means for adjusting its stiffness, the adjustment means including a flexible element arranged in series with the strip, the flexible element connecting one end of said strip to a rigid support, so as to add an additional stiffness to the strip sequence, the flexible element preferably having a stiffness greater than that of the strip, the adjustment means including prestressing means for applying a variable force or torque to the flexible element, so as to vary the stiffness of the flexible element, the prestressing means comprising a lever connected to the flexible element and actuatable to transmit the force or the torque to the flexible element by an actuator, the lever comprising an end movable in a first direction.

The invention is remarkable in that the spiral spring comprises retaining means arranged to prevent movement of the lever substantially in a second direction.

The invention avoids parasitic movements caused by friction between the actuator and the lever, which could move the lever in the second direction and distort the adjustment. In particular, by choosing the second direction substantially perpendicular to the first direction of movement of the lever, the actuator moves the lever in the first direction, even if the orientation of the spiral spring is changed.

In a particular embodiment of the invention, the retaining means connect the rigid support to the lever.

In a particular embodiment of the invention, the retaining means include a flexible guide.

In a particular embodiment of the invention, the flexible guide comprises a first translation table comprising two first flexible blades and a first rigid part.

In a particular embodiment of the invention, the flexible guide comprises a second translation table arranged in series with the first translation table, the second translation table comprising two second flexible blades and a second rigid part.

In a particular embodiment of the invention, the flexible guide comprises one single flexible blade.

In a particular embodiment of the invention, the flexible guide comprises a pair of uncrossed flexible blades.

In a particular embodiment of the invention, the retaining means comprise a second flexible lever.

According to a particular embodiment of the invention, the second direction is substantially perpendicular to the first direction of movement of the lever.

In a particular embodiment of the invention, the flexible element comprises a flexible blade.

In a particular embodiment of the invention, the torque or the force is continuously adjustable by the prestressing means.

The invention also relates to a rotary resonator mechanism, in particular for a watch movement, including an oscillating mass and such a spiral spring.

### BRIEF DESCRIPTION OF THE FIGURES

The aims, advantages and features of the present invention will become apparent from a number of embodiments given solely as non-limiting examples, with reference to the appended drawings wherein:

FIG. 1 schematically shows a top view of a spiral spring according to a first embodiment of the invention,

FIG. 2 schematically shows a top view of a spiral spring according to a second embodiment of the invention,

FIG. 3 schematically shows a top view of a spiral spring according to a third embodiment of the invention,

FIG. 4 schematically shows a top view of a spiral spring according to a fourth embodiment of the invention,

FIG. 5 schematically shows a top view of a spiral spring according to a fifth embodiment of the invention, and

FIG. 6 schematically shows a top view of a spiral spring according to a sixth embodiment of the invention.

### DETAILED DESCRIPTION OF THE INVENTION

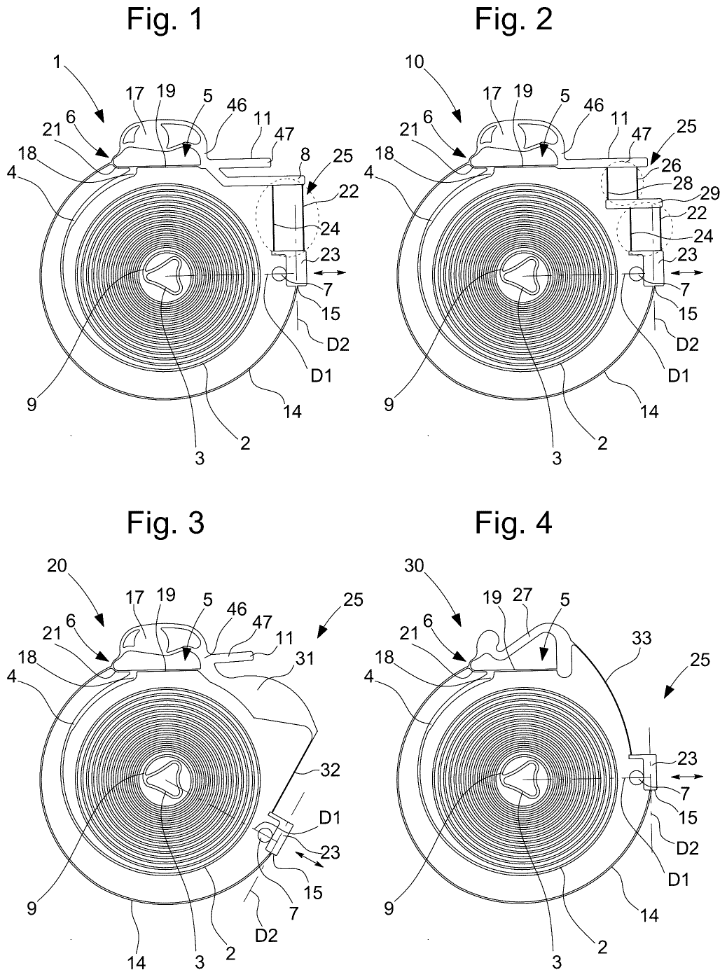

FIGS. 1 to 6 each show a schematic representation of a different embodiment of a spiral spring 1, 10, 20, 30, 40, 50, in particular for a regulating member of a watch resonator mechanism.

A regulating member generally comprises an inertial mass, such as an annular balance, a balance shaft and a balance bridge, not shown in the figures, and a spiral spring 1, 10, 20, 30, 40, 50 as an elastic return element for the inertial mass and configured to cause it to oscillate.

In these examples, each spiral spring 1, 10, 20, 30, 40, 50 extends in substantially the same plane.

The spiral spring 1, 10, 20, 30, 40, 50 comprises a flexible strip 2 wound on itself in several turns, the strip 2 having a predefined stiffness. The inner end 9 of the strip 2 is integral with or assembled to a support 3, generally referred to as a collet. The support 3 is substantially triangular in shape, so that it can be slipped around the shaft of the balance.

The spiral spring 1, 10, 20, 30, 40, 50 also includes means for adjusting its stiffness. For example, the adjustment means can in particular be actuated by a user when the regulating member is mounted on the plate of the watch movement.

The adjustment means include a flexible element 5 arranged in series with the strip 2, the flexible element 5 connecting an outer end 4 of said strip 2 to a rigid support 11 intended to be fixed relative to the flexible element 5. The flexible element 5 is secured to the outer end 4 of the strip 2. The flexible element 5 is a different element from the wound strip 2.

The flexible element 5 adds additional stiffness to that of the strip 2. The flexible element 5 is preferably stiffer than the strip 2. The flexible element 5 is herein arranged in the extension of the strip 2. Preferably, the adjustment means and the strip 2 are in one piece, or even made of the same material, for example silicon.

The flexible element 5 of the spiral spring 1, 10, 20, 30, 40, 50 comprises a first flexible blade 19 and a movable rigid part 18, which extends from the outer end of the strip 2, and is connected to the first flexible blade 19, preferably on the same side of the rigid part 18. The first flexible blade 19 is also connected to the rigid support 11.

The spiral spring 1, 10, 20, 30, 40, 50 adjustment means also include prestressing means 6 for applying a variable force or a torque to the flexible element 5. In this way, the stiffness of the spiral spring can be adjusted. The torque or the force is continuously adjustable by the prestressing means 6. In other words, the torque or the force is not restricted to point values. In this way, the stiffness of the flexible element 5 can be adjusted with great accuracy.

The prestressing means 6 include a secondary flexible blade and a curved semi-rigid part 21, arranged on an opposite side of the rigid part 18 in the extension of the first flexible blade 19.

The secondary flexible blade and the curved semi-rigid element 21 are connected at the other end to a curved lever 14 which runs around the strip 2. The secondary flexible blade and the curved semi-rigid element are connected to a rigid structure 17, 27, 37 linked to the rigid support 11.

The force or the torque is exerted on the free end 15 of the lever 14. The lever 14 of the prestressing means 6 thus transmits the force or the torque to the flexible element 5 via the secondary flexible leaf 19 so as to modify the stiffness of the spiral spring 1, 10, 20, 30, 40, 50.

In order to actuate the lever 14 and adjust the rate, the regulating member further includes an actuation system comprising an actuator 7 in contact with lever 14. The actuator is configured to push and/or pull the lever 14.

In the figures, the actuator 7 is represented by a circular body in contact with the lever 14 on the inner side towards the strip 2. Preferably, the actuator 7 comprises a hook at least partly surrounding the lever 14, preferably at a rigid part 23 arranged at the end 15 of the lever 14.

According to the invention, the spiral spring 1, 10, 20, 30, 40, 50 includes retaining means 25 for retaining the lever 14 in a second direction D2. The second direction D2 is substantially perpendicular to the movement in a first direction D1 of the end 15 of the lever 14 and the actuator 7. In this way, the lever is prevented from moving in this second direction D2, so that the adjustment of the rate is not distorted by such movement when it is to be adjusted by means of the actuator.

Indeed, if the spiral spring 1, 10, 20, 30, 40, 50 and the actuator 7 move relative to each other, the contact friction between them can cause the lever 14 to move sideways, resulting in an accuracy error in the rate adjustment.

Thanks to the retaining means 25, in the event of movement relative to each other, the retaining means 25 prevent lateral movement of the lever 14 due to friction.

In addition, when the actuator 7 pulls or pushes the end 15 of the lever 14, the latter moves only in the first direction D1 of movement of the actuator 7, so that it substantially maintains its position laterally with respect to the strip 2.

Preferably, these retaining means 25 include a flexible guide arranged between the lever and the rigid support 11 of the flexible element 5. Here between the lever and the rigid support 17.

In the first embodiment of FIG. 1, the flexible guide is a translation table.

The rigid support 11 is L-shaped, a first leg 46 of the L serving as a connection to the first flexible blade 19, and the second branch 47 of the L facing away from the first flexible blade 19 so that it can be assembled to the watch movement 10.

The rigid support 17 further comprises an arm 8 herein extending parallel to the second branch 47 of the L, towards the end 15 of the lever 14.

The translation table is equipped with two flexible blades 22, 24, which are substantially parallel, and a rigid part 23 which is movable relative to the arm 8, and on which the two flexible blades 21, 22 are mounted. The two flexible blades 22, 24 are connected to the arm 8 of the rigid support 17.

The rigid part 23 is assembled directly at the end of the lever 14.

Thanks to the translation table, the lever can move mainly in the first direction D1, which is substantially perpendicular to the flexible blades 22, 24 of the translation table, but not in the second direction D2, which is substantially parallel to the flexible blades in the rest position of the translation table. Indeed, the flexible blades 22, 24 hold the lever 14 in this second direction D2, but they allow the lever to move in the first direction D1.

The flexible element 5, the prestressing means 6 and the retaining means 25 form a closed circuit around the wound strip.

In the second embodiment of FIG. 2, the retaining means 25 include a second translation table arranged in series with the first translation table.

Here, the rigid support 17 of the flexible element 5 does not comprise an arm.

The first translation table is mounted at the end 15 of lever 14, like in the first embodiment.

The second translation table extends directly from the rigid support 11 of the flexible element 5. The second translation table comprises substantially parallel second flexible blades 25, 26 extending from the rigid support 11, as well as a second rigid part 29 movable relative to the rigid support 17, to which the second flexible strips 25, 26 are connected.

The first flexible blades 22, 24 are mounted on the second rigid part 29.

A second translation table allows increasing the distance covered by the lever 14 in the first direction D1, while maintaining a substantially straight line of movement.

FIG. 3 shows a third embodiment of the spiral spring 20 of FIG. 3, wherein the flexible guide comprises one single flexible blade 32 connecting the elastic element 5 to a rigid part 23 at the end 15 of the lever 14 via a half-moon-shaped body 31.

The half-moon-shaped body 31 is connected to the flexible element 5 on the one hand, and to the single flexible blade 32 on the other hand. Here, the flexible blade is straight in the rest position of the single flexible blade 32.

The single flexible blade 32 allows holding the lever 14 to prevent it from moving in a second direction D2 perpendicular to the first direction D1 of movement of the actuator 7.

Alternatively, as shown in the variant of FIG. 4, the flexible guide comprises a curved flexible blade 33. In this case, the rigid structure is S-shaped with no branches, half-moon-shaped body or rear arm. The curved blade 33 is mounted directly on the S-shaped rigid structure, and directly connects the rigid part 23 to the end 15 of the lever 14.

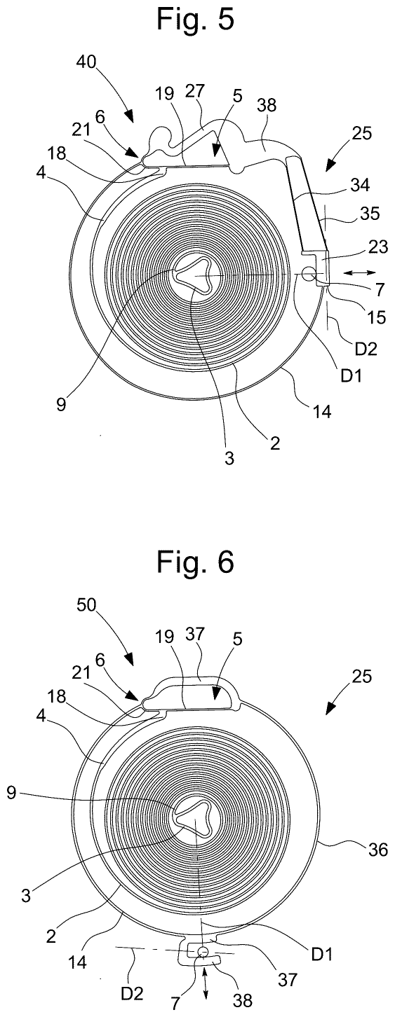

In FIG. 5, the flexible guide of the fourth embodiment comprises a flexible pivot with two uncrossed flexible blades 34, 35.

The rigid structure 27 is S-shaped with a rounded arm 38 extending rearwards. The two flexible blades 34, 35 are uncrossed from the tip of the rounded arm 38 up to the rigid part 23 at the end 15 of the lever 14.

The uncrossed blades 34, 35 have essentially the same effect as the blades of the translation table.

In the embodiment of FIG. 6, the retaining means 25 include a second flexible lever 36 arranged symmetrically to the first lever 14 around the flexible strip 2. The first lever 14 and the second lever 36 are joined together at a rigid junction 37 and form part of a ring around the strip 2.

The actuator 7 engages with the rigid junction 37 of the two levers 14, 36. The rigid junction 37 is U-shaped to enable the actuator 7 to be inserted inside the U.

The second lever 36 prevents the first lever from moving in the second direction D2 and allows it to remain movable in the first direction D1 only.

The invention also relates to a regulating member and a rotary resonator mechanism, in particular for a watch movement. The regulating member of the resonator mechanism includes an oscillating mass, not shown in the figures, and a spiral spring 1, 10, 20, 30, 40, 50 as described before. The oscillating mass is, for example, an annular balance. The oscillating mass is joined to the spiral spring so as to be secured to the support 3.

1. A spiral spring for a watch resonator mechanism, the spiral spring comprising:
a flexible strip wound on itself in a plurality of turns, the strip having a predefined stiffness, the spiral spring including means for adjusting its stiffness,
the adjustment means including a flexible element arranged in series with the strip, the flexible element connecting one end of the said strip to a rigid support, so as to add additional stiffness to the strip,
the flexible element having a stiffness greater than that of the strip,
the adjustment means including prestressing means for applying a variable force or torque to the flexible element, so as to vary the stiffness of the flexible element, the prestressing means comprising a lever connected to the flexible element and actuatable to transmit the force or the torque to the flexible element by an actuator, the lever comprising an end movable in a first direction (D1); and
retaining means arranged to prevent movement of the lever substantially in a second direction (D2).

2. The spiral spring according to claim 1, wherein the retaining means connect the rigid support to the lever.

3. The spiral spring according to in claim 1, wherein the retaining means include a flexible guide.

4. The spiral spring according to claim 3, wherein the flexible guide comprises a first translation table comprising two first flexible blades and a first rigid part.

5. The spiral spring according to claim 4, wherein the flexible guide comprises a second translation table arranged in series with the first translation table, the second translation table comprising two second flexible blades and a second rigid part.

6. The spiral spring according to claim 3, wherein the flexible guide comprises one single flexible blade.

7. The spiral spring according to claim 3, wherein the flexible guide comprises a pair of uncrossed flexible blades.

8. The spiral spring according to claim 2, wherein the retaining means comprise a second flexible lever.

9. The spiral spring according to claim 1, wherein the second direction (D2) is substantially perpendicular to the first direction (D1) of movement of the lever.

10. The spiral spring according to claim 1, wherein the flexible element comprises a flexible blade.

11. The spiral spring according to claim 1, wherein the torque or the force is continuously adjustable by the prestressing means.

12. A rotary resonator mechanism for a watch movement, including an oscillating mass, and comprising the spiral spring according to claim 1.
